(19) United States
(12) Patent Application Publication
(10) Pub. No.: US 2022/0374809 A1
(43) Pub. Date: Nov. 24, 2022

(54) COMPUTER-BASED TRACKING AND DETERMINING IMPACT OF EVENTS ON CONTACT CENTER OPERATIONS

(71) Applicant: Wells Fargo Bank, N.A., San Francisco, CA (US)

(72) Inventors: Paul Gaspar, Del Mar, CA (US); Debashis Ghosh, Charlotte, NC (US); Fredrick W. Lambuth, San Antonio, TX (US); Maria Chiarenza, Indian Trail, NC (US); Richard Claude Robert Trent, Newton, NC (US)

(21) Appl. No.: 17/124,074

(22) Filed: Dec. 16, 2020

(51) Int. Cl. G06Q 10/06; H04M 3/51

(52) U.S. Cl. CPC G06Q 10/06393; G06Q 10/063114; H04M 3/5175; G06Q 10/06312

(57) ABSTRACT

An event log computing system receives event data associated with one or more events that may impact operations of a contact center. The event log system may analyze event data and one or more contact center performance metrics to determine an actual impact level of the event on each of the one or more contact center performance metrics. The event log system may also analyze anomalies in one or more contact center performance metrics and event data in the event log to identify events in the event log that may be associated with the anomalies.

### TECHNICAL FIELD

The disclosure relates to computing systems, and more specifically, computing systems that monitor and/or control operations of a contact center.

### BACKGROUND

A contact center is a facility configured to handle incoming voice calls from customers or potential customers of a business or organization. One function of the contact center is to handle customer service inquiries focused on customer accounts with the organization, i.e., servicing existing accounts and opening new accounts. Although many customer service inquiries can be handled through online interactions (e.g., via websites, email, or mobile applications), for some organization, a contact center may be regarded as necessary. Customers of banks, for example, may prefer to speak to a live person when resolving service issues. A contact center may include one or more interactive voice response (IVR) systems and one or more agent desktop systems used by a number of human agents that are representatives of the business. The IVR systems and agent desktop systems may be considered front-end systems of the contact center with which the customers directly interact to resolve their service inquiries. In addition to the front-end systems, the contact center may also include or interact with multiple back-end systems to access information about the organization or about existing customers of the organization in order to properly service a customer's voice call.

### SUMMARY

In general, this disclosure describes computing systems and methods that control or monitor operation of a contact center. In accordance with some techniques of the present disclosure, an event log system receives event data relating to one or more events that may impact operation of a contact center. The event log system may analyze event data and one or more contact center performance metrics to determine an actual impact level of the event on each of the one or more contact center performance metrics. The event log system may also analyze anomalies in one or more contact center performance metrics and event data in the event log to identify events in the event log that may be associated with the anomalies.

The techniques of this disclosure may provide one or more advantages. The event log system presents a guided and user-friendly interface for users to input event data relating to one or more events that may impact operation of the contact center. The events may include scheduled events and/or unscheduled events. In some examples, therefore, one or more techniques of this disclosure enable contact center operations to visualize and/or respond to events that can be controlled in advance (e.g., scheduled events) and unexpected events (e.g., unscheduled events). A detailed understanding of each event may assist contact center operations in making decisions as to whether a response(s) to a scheduled or an unscheduled event is required, and/or to determine one or more response(s) that may best address the determined impact of the event.

The event data may include an event name, an event date, an event type, a list of one or more performance metrics potentially impacted by the event, an estimated impact level associated with the event, and any other data related to the event. The event data for one or more events may be stored in an event log (such as a database). The event log system may analyze event data and one or more contact center performance metrics to determine an impact of the event on the one or more contact center performance metrics. The event log computing system may also analyze event data and anomalies in contact center performance metrics to identify whether any events in the event log are related to the anomalies in the contact center performance metrics. Analysis of the event data may thus be used to provide insights into the operations of the contact center, such as providing reasoning for anomalies or failure to meet forecasts in one or more contact center performance metrics, or to help anticipate how certain events may affect operation of the contact center and allow the contact center to adapt to the occurrence of an event.

In one examples, the disclosure is directed to a computing system comprising memory; and one or more processors in communication with the memory and configured to receive event data associated with an event from one or more user devices, wherein the event is estimated to impact operations of a contact center; analyze one or more contact center performance metrics and the event data to identify anomalies in the one or more contact center performance metrics associated with the event; determine, for each of the contact center performance metrics, an impact level of the event corresponding to an actual impact that the event had on the contact center performance metric; and generate, for display on a user computing device, one or more reports indicative of the event data, the contact center performance metrics, and the impact level.

In another example, the disclosure is directed to a method comprising receiving, by one or more processors, event data associated with an event that may impact operations of a contact center from one or more user devices; analyzing, by the one or more processors, one or more contact center performance metrics and the event data to identify anomalies in the one or more contact center performance metrics that may be associated with the event; determining, by the one or more processors and for each of the contact center performance metrics, an impact level of the event corresponding to an actual impact that the event had on the contact center performance metric; and generating, by the one or more processors and for display on a user computing device, one or more reports indicative of the event data, the contact center performance metrics, and the impact level.

In another example, the disclosure is directed to a computer readable medium comprising instructions that when executed cause one or more processors to receive event data associated with an event that may impact operations of a contact center from one or more user devices; analyze one or more contact center performance metrics and the event data to identify anomalies in the one or more contact center performance metrics that may be associated with the event; determine, for each of the contact center performance metrics, an impact level of the event corresponding to an actual impact that the event had on the contact center performance metric; and generate, for display on a user computing device, one or more reports indicative of the event data, the contact center performance metrics, and the impact level.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example contact center within a network that includes an event log system configured to receive and store event data associated with one or more events that may impact operations of the contact center, in accordance with one or more techniques of this disclosure.

FIG. 2 is a block diagram illustrating an example event log computing system, in accordance with one or more techniques of this disclosure.

FIGS. 3A-3B show an example event log interface by which an event log computing system may receive event data input by a user, in accordance with one or more techniques of this disclosure.

FIG. 4 is a graph showing example call volume and average handle time performance metric data for a contact center.

FIG. 5 shows a table including example performance metric data as displayed on a user interface of a user computing device, in accordance with one or more techniques of this disclosure.

FIG. 6 shows an example map chart that may be generated by an event log computing system, including geographic data associated with an event, in accordance with one or more techniques of this disclosure.

FIG. 7 shows an example calendar chart that may be generated by an event log computing system, including event log data over a period of time, in accordance with one or more techniques of this disclosure.

FIG. 8 is a flowchart illustrating an example event log data input process by which an event log computing system may receive and store annotation data input by a human user into an event log interface, in accordance with one or more techniques of this disclosure.

FIG. 9A is a flowchart illustrating an example process by which an event log computing system may analyze event data and contact center performance metrics to identify how an event impacted the one or more contact center performance metrics.

FIG. 9B is a flowchart illustrating an example process by which an event log computing system may analyze event data and anomalies in contact center performance metrics to identify events in the event log that may be related to the anomalies in the performance data.

### DETAILED DESCRIPTION

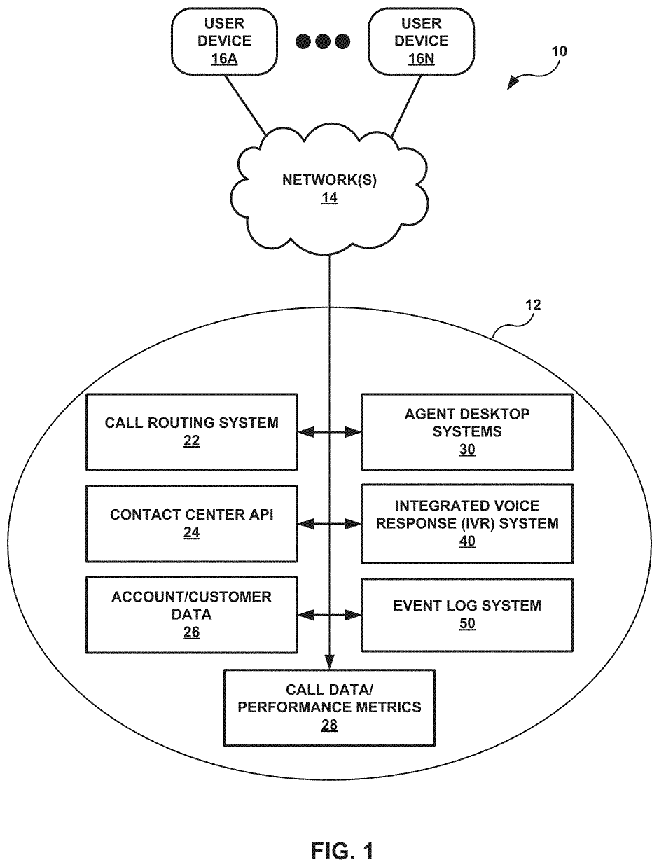

FIG. 1 is a block diagram illustrating an example contact center 12 within a network 10 that includes an event log system 40 configured to receive and store event data associated with one or more events that may impact operations of the contact center, in accordance with one or more techniques of this disclosure. As illustrated in FIG. 1, network 10 includes one or more user devices 16A-16N (collectively “user devices 16”) in communication with contact center 12 via one or more network(s) 14.

Contact center 12 is a facility configured to handle incoming voice calls from user devices 16 operated by users that may be customers or non-customers of a business or organization. In some cases, contact center 12 may be referred to as a call center. Contact center 12 includes several disparate computing systems configured to handle customer service inquiries. When the organization is a bank or other financial services institution, for example, contact center 12 may be configured to handle customer service inquiries associated customer accounts, such as servicing existing accounts, opening new accounts, etc. Contact center 12 may be especially useful for those customers that prefer to speak to a live person when resolving service issues or that feel more comfortable sharing personal information over a voice channel than an online channel (e.g., website, email, or mobile application). Contact center 12 may also provide certain services that may not be available via online channels, such as opening new accounts with the organization.

User devices 16 may be any suitable communication or computing device, such as a conventional or landline phone, or a mobile, non-mobile, wearable, and/or non-wearable computing device capable of communicating over communications network(s) 14. One or more of user devices 16 may support communication services over packet-switched networks, e.g., the public Internet, including Voice over Internet Protocol (VOIP). One or more of user device 16 may also support communication services over circuit-switched networks, e.g., the public switched telephone network (PSTN).

Each of user devices 16 is operated by a user (i.e., the caller) that may be a customer or a non-customer of the organization that provides contact center 12. In the case of a business or corporate customer, the user may be a representative of the business or corporate customer. In general, each of user devices 16 may represent a landline phone, a conventional mobile phone, a smart phone, a tablet computer, a computerized watch, a computerized glove or gloves, a personal digital assistant, a virtual assistant, a gaming system, a media player, an e-book reader, a television or television platform, a navigation, information and/or entertainment system for a bicycle, automobile or other vehicle, a laptop or notebook computer, a desktop computer, or any other type of wearable, non-wearable, mobile, or non-mobile computing device that may perform operations in accordance with one or more aspects of the present disclosure. Although not shown in FIG. 1, one or more of user devices 16 may be associated with a display device, e.g., either integrated within the user device or in communication with the user device, on which to present a user interface.

Network(s) 14 may include one or more computer network(s) (e.g., a wide area network (WAN), such as the Internet, a local area network (LAN), or a virtual private network (VPN)), a telephone network (e.g., the PSTN or a wireless network), and/or any other wired or wireless communication network. Although illustrated as a single entity, network(s) 14 may comprise a combination of multiple networks.

Contact center 12 may comprise a centralized or distributed network of disparate computing systems made up of interconnected desktop computers, laptops, workstations, wireless devices, network-ready appliances, file servers, print servers, or other computing devices. For example, contact center 12 may comprise one or more data centers including a plurality of servers configured to provide account services interconnected with a plurality of databases and other storage facilities in which customer credentials, customer profiles, and customer accounts are stored. Contact center 12 may include both “front-end systems” with which the customers or non-customers of the organization directly interact to resolve service inquiries, and “back-end systems” that support operation of the contact center 12 itself, or that manage, analyze, and/or store information concerning the organization, accounts, existing customers and other data associated with the organization.

In the example of FIG. 1, contact center 12 includes one or more agent desktop systems 30 used by a one or more human agents that are representatives of the organization and one or more interactive voice response (IVR) systems 40. Agent desktop systems 30 and IVR systems 40 may be considered “front-end systems.” In this example, the front-end systems may be used by the organization to interact with its customers to resolve customer service inquiries. Contact center 12 also includes a call routing system 22, a contact center applications program interface (API) 24, and an event log system 50. Call routing system 22, API 24 and event log system 50 may be considered “back-end systems.” Contact center 12 also includes one or more data storage devices 26 that store and/or manage account and/or customer data associated used or generated by contact center 12. Contact center 12 also includes one or more data storage devices 28 that store and/or manage call data and/or contact center performance metrics associated with operation of contact center 12.

In this example, the back-end systems may be tools used by the organization to facilitate the functions of contact center 12, including collecting, storing, and maintaining data used by contact center 12. For example, contact center API 24 provides a computing interface that controls interactions between the multiple computing systems of contact center 12. Call routing system 22 routes inbound calls to one or more of agent desktop systems 30 and/or IVR systems 40.

In accordance with one or more technique of this disclosure, event log system 50 presents a guided and user-friendly interface for users to input event data relating to one or more events that may impact operations of the contact center. The events may include scheduled events and/or unscheduled events. Event log system 50 may analyze event data associated with an event and one or more contact center performance metrics to determine an impact of the event on the one or more contact center performance metrics. Event log system 50 may also analyze event data associated with one or more events in the event log and anomalies in contact center performance metrics to identify whether any of the one or more events in the event log had an impact on the anomalies in the contact center performance metrics. In some examples, therefore, one or more techniques of this disclosure enable contact center operations to visualize and/or respond to events that can be controlled in advance (e.g., scheduled events) and unexpected events (e.g., unscheduled events). A detailed understanding of each event may assist contact center operations in making decisions as to whether a response(s) to a scheduled or an unscheduled event is required, and/or to determine one or more response(s) that may best address the determined impact of the event.

The architecture of contact center 12 illustrated in FIG. 1 is shown for exemplary purposes only and should not be limited to this architecture. In other examples, contact center 12 may include more, fewer, or different computing systems configured to handle customer service inquiries.

In the example of FIG. 1, one of user devices 16, e.g., user device 16A, may initiate a call to contact center 12 in response to input from a user of user device 16A. User device 16A outputs a signal over network(s) 14.

Contact center 12 receives the inbound call from network(s) 14. Call routing system 22 determines whether to route the inbound call to one of IVR systems 40 or one of agent desktop systems 30. Call routing system 22 may route calls to one of a number of destinations, including to IVR systems 40, agent desktop systems 30, or to other devices, users, or systems. In some examples, call routing system 22 may be implemented using call routing solutions available through Genesys Telecommunications Laboratories. In an example where user device 16A requests to speak with a human agent or selects a service that can only be performed by a human agent, call routing system 22 routes the call to one of agent desktop systems 30, thereby enabling a user of user device 16A and a human agent at the one of agent desktop systems 30 to engage in a voice communication session. In an example where user device 16A selects a service for which an IVR program is available, call routing system 22 routes the call to the appropriate one of IVR systems 40, thereby enabling the user of user device 16A to interact with the IVR system 40.

One or more of IVR systems 40 and/or the human agents at agent desktop systems 30 may process account service inquiries received from the customer via user device 16A. In the example of a bank or other financial institution, the account service inquiries may include account balance inquiries, most recent transaction inquiries, money transfers, opening or closing accounts, updating or resetting security credentials, changing or rebalancing investment funds, and the like. IVR systems 40 and the human agents at agent desktop systems 30 may process the account service inquiries by accessing customer accounts and/or accessing customer profiles as stored in data storage device(s) 26.

In one or more examples in accordance with the techniques of the present disclosure, event log system 50 may guide one or more human users through an event log process by which event data associated with an event that may impact operations of the contact center is received. For example, event log system 50 may present one or more event log interfaces at agent desktop systems 30 that guide a human user through an event log data input process by which the human user inputs event data associated with an event. In this way, event log system 50 may receive event data corresponding to each event. Event log system 50 saves the event data received from each user in one or more storage devices. For example, event log system 50 may include or have associated with it one or more storage devices, such as one or more event log databases, in which the event data corresponding to each event may be stored.

In accordance with one or more techniques of this disclosure, event log system 50 may analyze event data associated with an event and one or more contact center performance metrics to determine an impact of the event on the one or more contact center performance metrics. Event log system 50 may also analyze event data associated with one or more events in the event log and anomalies in contact center performance metrics to identify whether any of the one or more events in the event log had an impact on the anomalies in the contact center performance metrics.

The contact center performance metrics may include, but are not limited to, any one or more of the performance metrics listed in Table 1:

TABLE 1

| Performance Metric | Acronym | Description |
|---|---|---|
| Number of Calls Offered | NCO | Total number of calls available to be answered in the live |
| | | agent queue within a specific time frame. |
| NCO Percent of Forecast | % Fcst | Percent above or below forecasted NCO. |
| Number of Calls Handled | NCH | Total number of calls handled within a specific time frame. |
| Rate of Abandoned Calls | ABA | Rate of abandoned calls during a specific time frame. |
| Target Service Level | Tgt SVC LVL | Percentage of calls answered within a specific time frame. |
| Average Speed of Answer | ASA | Average time it takes for calls to be answered. |
| Average Talk Time | ATT | Average amount of time an agent actually on the phone with |
| | | a customer. |
| After Call Work Time | AWT | Average time it takes agents to do the work associated with |
| | | a call after it is finished. |
| Average Handle Time | AHT | Average time from when agent answers the phone until they |
| | | disconnect the call (indicative of how long it took for agent |
| | | to address the customer inquiry). |
| AHT Percent of Forecast | AHT % Fcst | Percent above or below forecasted AHT. |

Each performance metric may include a target value for the performance metric and an actual value for the performance metric. The target value for each performance metric may be determined based on one or more specified time frame(s), such as specified minutes or hours of the day (e.g., any specified time periods within a single day), day of the week (e.g., Sunday-Saturday), week of the year (e.g., week 1-week 52), month (January-December), year, etc. The actual value for each performance metric may be measured for the same time frame(s) as the associated target performance metric. The performance metrics may further include any values that may be calculated based on the target and/or actual performance metrics, such as actual-to-target ratios or percentages, for any one or more of the specified time frame(s).

In accordance with one or more techniques of this disclosure, event log system 50 may analyze event data associated with an event and one or more contact center performance metrics to determine an impact of the event on the one or more contact center performance metrics. For example, event log system 50 may analyze event data to determine the date and time that an event occurred. Event log system 50 may further analyze one or more contact center performance metrics during one or more time frames occurring either before or after occurrence of the event to identify whether the event had an impact on the one or more performance metrics. For example, event log system 50 may track the data on call center metrics during a predetermined period of time (e.g., 14 days, 7 days, 2 days, or any other appropriate time frame, etc.) before and after an event to determine whether the event had an impact on the call center in a negative manner. Statistical hypothesis testing may be conducted to ensure that the results are statistically significant before any action is taken.

In accordance with one or more techniques of this disclosure, event log system 50 may analyze event data associated with one or more events in the event log and anomalies in contact center performance metrics to identify whether any of the one or more events in the event log caused or resulted in the anomalies in the contact center performance metrics. For example, event log system 50 may analyze the anomalies in contact center performance metrics to determine the date(s) and/or time(s) associated with the anomalies. Event log system 50 may further analyze one or more events occurring within a threshold amount of time of the anomalies to identify one or more events that may have caused or resulting in the anomalies in the contact center performance metrics. For example, event log system 50 may track the data on call center metrics during a predetermined period of time (e.g., 14 days, 7 days, 2 days, or any other appropriate time frame, etc.) before and after an event to determine whether the event affected the call center in a negative manner. Statistical hypothesis testing may be conducted to ensure that the results are statistically significant before any action is taken.

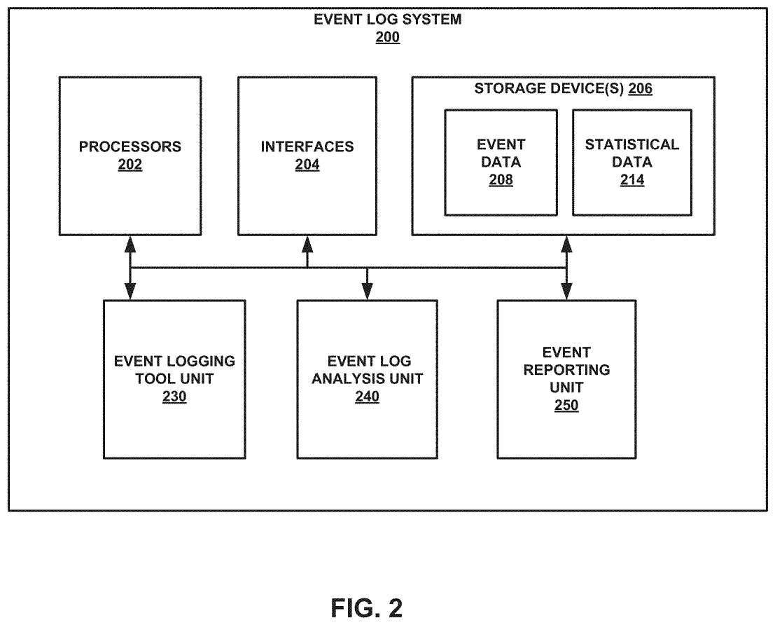

FIG. 2 is a block diagram illustrating an example event log system 200, in accordance with one or more techniques of this disclosure. Event log system 200 of FIG. 2 may be described as an example or alternative implementation of event log system 50 within message center 12 of FIG. 1. One or more aspects of event log system 200 of FIG. 2 may be described within the context of message center 12 of FIG. 1. The architecture of event log system 200 illustrated in FIG. 2 is shown for purposes of example only, and it shall be understood that the disclosure is not limited in this respect.

Event log system 200 provides a structured system by which event data associated with one or more events is received, managed and/or analyzed. Event log system 200 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, annotation management system 200 represents a cloud computing system, server farm, and/or server cluster (or portion thereof) that provides services to client devices and other devices or systems. In other examples, event log system 200 may represent or be implemented through one or more virtualized compute instances (e.g., virtual machines, containers) of a data center, cloud computing system, server farm, and/or server cluster.

As shown in the example of FIG. 2, event log system 200 includes one or more processors 202, one or more interfaces 204, and one or more storage units 206. Event log system 200 further includes an event logging tool unit 230, an event log analysis unit 240, and an event log reporting unit 250. Storage units 206 of event log system 200 may also store an operating system (not illustrated in FIG. 2) executable by processors 202 to control the operation of components of event log system 200. The components, units, or modules of event log system 200 are coupled (physically, communicatively, and/or operatively) using communication channels for inter-component communications. In some examples, the communication channels may include a system bus, a network connection, an inter-process communication data structure, or any other method for communicating data.

Processors 202, in one example, may comprise one or more processors that are configured to implement functionality and/or process instructions for execution within event log system 200. For example, processors 202 may be capable of processing instructions stored by event logging tool unit 230, event log analysis unit 240, and/or reporting unit 250. Processors 202 may include, for example, microprocessors, digital signal processors (DSPs), application specific integrated circuits (ASICs), field-programmable gate array (FPGAs), or equivalent discrete or integrated logic circuitry, or a combination of any of the foregoing processing devices or circuitry.

Event log system 200 may utilize interfaces 204 to communicate with, for example, any one or more of call routing system 22, contact center API 24, agent desktop systems 30, and/or IVR system 40 as shown in FIG. 1. Annotation management system 200 may also utilize interfaces 204 to communicate with external systems or computing devices via one or more networks, e.g., network(s) 14 of FIG. 1. The communication may be wired, wireless, or any combination thereof. Interfaces 204 may be network interfaces (such as Ethernet interfaces, optical transceivers, radio frequency (RF) transceivers, Wi-Fi or Bluetooth radios, or the like), telephony interfaces, or any other type of devices that can send and receive information.

Storage units 206 may be configured to store information within event log system 200. Storage units 206 may include one or more computer-readable storage media or computer-readable storage device(s). In some examples, storage units 206 include one or more of a short-term memory or a long-term memory. Storage units 206 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage units 206 are used to store program instructions for execution by processors 202. Storage units 206 may be used by software or applications running on event log system 200 to temporarily store information during program execution.

Storage units 206 also store data associated with event log process(s) executed by event log system 200. For example, storage units 206 may store including an event log database that stores event data 208. The event data may include any data that may be associated with or that describes an event. For example, the event data may include an event name, a start date and/or time associated with an event, an end date and/or time associated with an event, an event type, an impact type (such as an estimate of which contact center performance metrics may be impacted), an estimated impact level, an actual impact level, an estimated customer experience impact, an actual customer experience impact, an estimated list of one or more lines of business expected to be impacted by the event, a list of one or more lines of business that actually were impacted by the event, and any other data that may be associated with an event.

Event logging tool unit 230 of event log system 200 includes computer programmed instructions that, when executed by the one or more processors 202 of event log system 200, cause processors to generate one or more event log interfaces for display at, for example, one or more of agent desktop systems 30, that guide a human user through an event log process by which the human user inputs event data associated with an event. The event log interface(s) may include any combination of one or more graphic interface control elements (also referred to herein as “interface elements”), such as text entry boxes, check boxes, toggle switches, radio buttons, drop-down lists, buttons, tabs, or windows, or any other interface element through which a user may input event data associated with an event. The event log interface(s) may include one or more interface elements that include a list of predetermined options from which a user may select, such as yes/no selectors, drop-down lists, context menu, toggle switches, etc. The event log interface(s) may further include one or more interface elements that permit a user to input free text describing an event, such as a text entry box, etc.

Event log analysis unit 240 includes computer programmed instructions that, when executed by the one or more processors 202 of event log system 200, cause processors to analyze event data associated with an event and one or more contact center performance metrics to determine an impact of the event on the one or more contact center performance metrics. Event log analysis unit 240 may also include instructions that, when executed by the one or more processors 202 of event log system 200, cause processors to analyze event data associated with one or more events in the event log and anomalies in contact center performance metrics to identify whether any of the one or more events in the event log caused or resulted in the anomalies in the contact center performance metrics.

Statistical data 214 includes data resulting from analysis of event data 208 and/or the performance metrics as executed by event log analysis unit 240. Event log analysis unit 240 may include computer programed instructions that, when executed by the one or more processors 202, cause processors to perform one or more types of statistical analysis on the event data and/or the performance metrics. For example, event log system 50 may track the data on call center metrics during a predetermined period of time (e.g., 14 days, 7 days, 2 days, or any other appropriate time frame, etc.) before and after an event to determine whether the event affected the call center in a negative manner. Statistical hypothesis testing may be conducted to ensure that the results are statistically significant before any action is taken.

Reporting unit 250 may include computer programed instructions that cause the one or more processors 202 to execute a report generation process through which one or more reports are generated in response to requests received from one or more human users. In addition, or alternatively, one or more reports may be generated automatically. For example, reporting unit 250 may allow one or more human users to request generation of one or more event reports and generate the event reports in response to the request. Reporting unit may generate one or more reports based on user input received via one or more user interfaces generated by event log unit 230. The reports may include any one or more of event data 208, statistical data 214, performance metrics, and/or any data generated therefrom. For example, the reports may include charts, tables, and/or graphs illustrating any of the performance metrics (which may be stored, for example, as performance metrics 28 of FIG. 1) data stored in storage units 206 and/or generated by event log analysis unit 240, such as graphs indicating trends over time, and calculated statistics associated with any of the data stored in storage units 208 or generated by any of the event log processes carried out by event log analysis unit 240 and/or reporting unit 250. The reports may be displayed on a user interface of a user computing device such that the user may interact with the reports via the user interface.

As another example, one or more report(s) may be automatically generated and sent to another computing system for analysis and/or response. For example, event log system 200 may automatically generate and send reports to one or more other computing systems that may then automatically take some action, such as taking one or more action(s) to automatically address a negative impact of an event or one or more action(s) to alleviate a negative impact of an event.

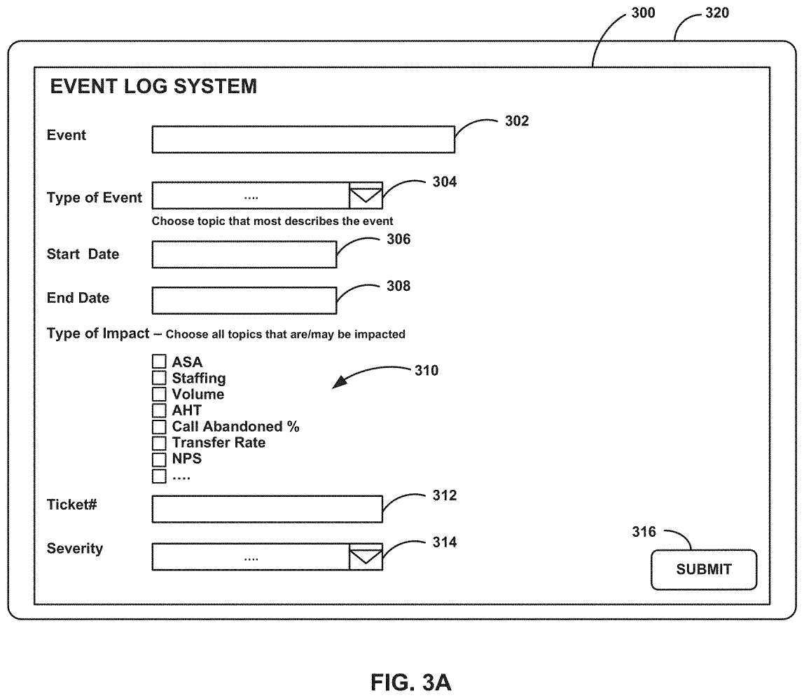

FIGS. 3A and 3B show an example event log interface 300 that may be output by event log system 200 of FIG. 2 and displayed on a computing device 320 (such as agent desktop systems 24), and through which a human user may enter event data associated with an event that may have an impact on operations of a contact center. Example event log interface 300 may be generated by event log tool unit 230 of FIG. 2. It shall be understood that although a specific example of an event log interface 300 is shown and described herein, that many alternative interfaces may be used to receive event data from one or more human users, and that the disclosure is not limited in this respect.

Event log interface 300 includes one or more text entry/editing fields and one or more graphical interface control elements such as text entry boxes, check boxes, drop-down lists, buttons, tabs, etc., through which a human user may navigate the event log process and enter event data. For example, when an event is brought to the attention of an authorized user, the user may navigate to the event log system so that event log interface 300 is displayed on user computing device 320.

In the example of FIG. 3A, event log interface 300 includes an interface element, such as a text entry box 302, where a user may input a name for the event. The event name may be determined by the user or may be chosen in accordance with a naming convention established by the organization. A unique event identification number associated with the event may be automatically generated and populated in Ticket Number field 312. Start Date field 306 is a calendar entry field where a user may select a date that is associated with the start of the event. End Date field 306 is a calendar entry field where a user may select a date that is associated with the end of the event. The start and end dates may be the same day if the event occurred in a single day. Event log interface 300 further includes one or more check boxes by which the user may select one or more categories that have been, or that the user perceives may be, impacted by the event. For example, the categories that may be impacted by the event may include any one or more of the contact center performance metrics, or any one or more of other contact center parameters such as the number of contact center agents staffed, etc.

As shown in FIG. 3B, event log interface 300 may further include one or more interface elements 322, such as one or more checkboxes, indicative of the estimated impact level the user estimates the event will have on the operations of the contact center. In this example, the choices for estimated impact level include high impact, moderate impact, low impact, and no impact. The user may select one of the listed impact levels based on their own estimate of the impact level that the event will have on operations of the contact center. If the event is input into event log system 200 after occurrence of the event, the user may select an impact level based on analysis of the event data associated with the event and/or one or more contact center performance metrics. The estimated impact level 322 may be local (e.g., site specific), a group of one or more specific sites, or the contact center as a whole (e.g., all sites).

Event log interface 300 may further include one or more interface elements 324, such as one or more checkboxes, indicative of the impact level the user estimates the event will have on customer experience scores for the contact center. In this example, the choices for customer experience impact include high impact, moderate impact, low impact, and no impact. The user may select one of the listed impact levels based on their own estimate of the impact level that the event will have on customer experience scores for the contact center. If the event is input into event log system 200 after occurrence of the event, the user may select a customer experience impact level based on analysis of the event data associated with the event and/or one or more contact center performance metrics.

Event log interface 300 may further include one or more interface elements 326, such as one or more checkboxes, indicative of the lines of business that may be impacted by the event. As shown in the example of FIG. 3B, when the organization is a financial services institution, the lines of business may include, but are not limited to, everyday banking services, premier banking services, credit cards, sales, executive services, and any other line of business associated with the organization. The user may select one or more of the lines of businesses they believe may be impacted by the event. If the event is input into event log system 200 after occurrence of the event, the user may select the one or more lines of business based on analysis of the event data associated with the event and/or one or more contact center performance metrics.

When a user has completed input of the event data via event log interface 300, the user may select the submit button 328. Event log system 200 may then store the event data input into the event log interface in the event log database 208.

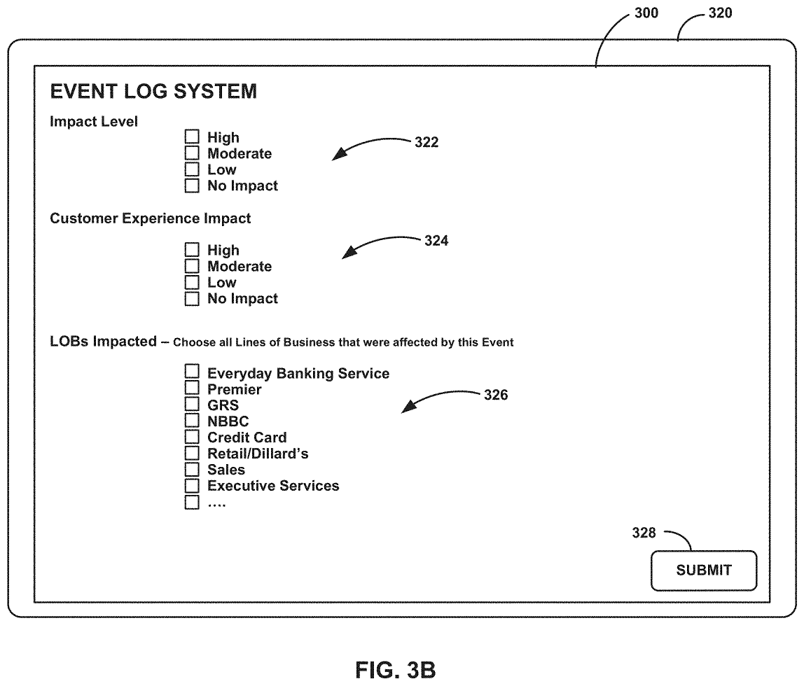

FIG. 4 is a graph 400 showing example call volume and average handle time performance metric data for a contact center. This graph shows an example of how an event log system, such as event log system 50, 200 as shown in FIGS. 1 and 2, may analyze event data associated with an event and one or more contact center performance metrics to determine an impact of the event on the one or more contact center performance metrics.

In the example of FIG. 4, assume that an IT event that prevented logins to customer mobile banking accounts on Oct. 21, 2020 between 10:30 pm and 11:00 pm. Upon being made aware of the occurrence of this event, an authorized user entered the event data into the event log system 200, such as via event log interface 300 as shown in FIGS. 3A and 3B. Assume further that the user input an estimated impact level of “Moderate” and selected average speed of answer (ASA), call volume (NCO), and target service level (SVL) as an estimated list of impacted performance metrics. Further assume that the user input an estimated customer experience impact of “High.”

Event log system 200 may analyze the event data input into event log interface 300 associated with this event together with one or more contact center performance metrics to determine an impact of the event on the one or more contact center performance metrics.

FIG. 4 shows an example of two performance metrics for a period of time from Sep. 1, 2020 to Oct. 25, 2020. Curve 402 is a graph of daily percent actual as compared to the forecast call volume (NCO) performance metric, and curve 404 is a graph of daily percent actual as compared to the forecast average handle time (AHT) performance metric. In the example graphs 402 and 404, if the actual value on a particular day was the same as the forecasted value for that particular day, the percent actual to forecast would be 0%. In this example, an anomaly is present in the % actual to forecast call volume performance metric on Oct. 21, 2020. That is, in this example, the actual call volume is about 27% over forecast as indicated by the % actual to forecast call volume performance metric graph 402 on Oct. 21, 2020.

To identify anomalies in a performance metric, event log system 200, using event log analysis unit 240 may determine whether there is at least a threshold difference between the actual value for a performance metric as compared to the forecasted value for the performance metric. In the example of FIG. 4, if the threshold for the percent actual to forecast call volume is, for example, 10% over forecast, event log system 200 would identify the percent actual to forecast call volume of 27% percent over forecast that occurred on Oct. 21, 2020 at 10:30-11:00 pm as an anomaly.

Event log system 200 may further analyze the event data associated with the event and one or more performance metrics to determine the actual impact that the event had on the one or more performance metrics. This may give users analytical insights into the operations of the contact center, putting the event into perspective as to whether the actual impact was more or less significant than expected, and to give insight into how the operations of the contact center may be modified or adjusted to prevent future events from having undesirable impact on the one or more performance metrics.

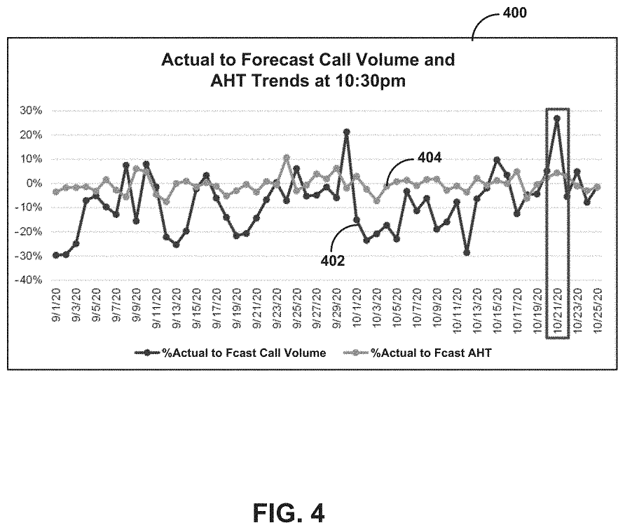

For example, FIG. 5 is a table 502 showing example performance metric data for the date Oct. 21, 2020 as displayed on a user interface 500 of a user computing device 530. Each row 504A-504N of table 502 includes performance metric data for the specified 30 minute time interval. In this example, the time interval corresponding to Oct. 21, 2020 at 10:30-10:59 pm is shown in row 504N and shows that forecast NCO performance metric (number of calls offered) was 1442 and the total (actual) NCO performance metric was 1830. The calculated % actual to forecast NCO was 26.91% as shown in the second column of row 504N. This corresponds to the value of curve 402 of graph 400 as shown in FIG. 4. To gain further insights into the impact of this event, event log system may further analyze one or more other performance metrics during the same time frame to determine the impact of the event on those other performance metrics during the time frame of the event. In this example, the average handle time (AHT) was 4.44% over forecast. The average speed of answer (ASA) was 3 seconds, and the target service level (SVL) was 99.6%.

Event log system may further analyze one or more performance metrics during one or more other time frames (such as the entire day Oct. 21, 2020) to identify the impact the event had on the performance metrics for the day as a whole. In this example, the performance metrics for the entire day (not shown in FIG. 5) indicated that the call volume for the day was 5% over forecast and the target service level (SVL) was 99.6%. Thus, event log system 200 may determine that the event had little effect on the day as a whole. If the event had a longer duration, it may have had a bigger impact on the performance metrics for the day.

To determine the impact level for an event, event log system 200 may set thresholds for each of no impact, low impact, moderate impact, and high impact for each performance metric. Event log system 200 may then determine whether each performance metric exceeds the associated threshold(s). Event log system 200 may further generate a report indicating data for each performance metric and whether the associated threshold(s) for each performance were exceeded. Event log system may further aggregate the determined impact level(s) from one or more performance metrics to determine an overall impact score for the event. As another example, event log system 200 may set up the threshold(s) with standard deviation thresholds from the expected levels (e.g., one standard deviation, two standard deviations, three standard deviations, etc.).

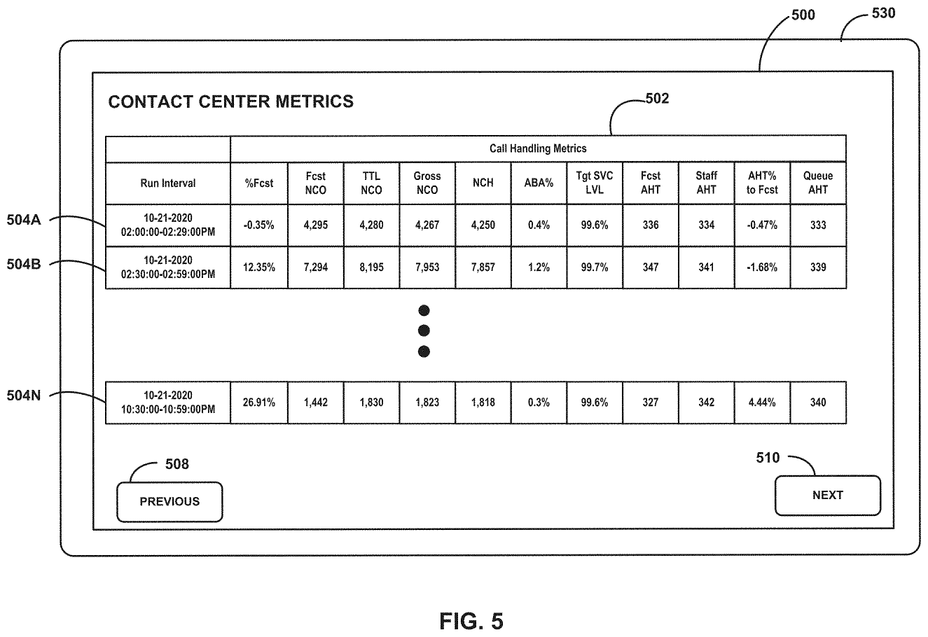

FIG. 6 shows an example map chart 600 that may be generated by a reporting unit, such as reporting unit 250 of event log system 200 as shown in FIG. 2, including geographic data associated with an event, and displayed on a user computing device 620, in accordance with one or more techniques of this disclosure. In this example, map chart 600 includes geographic data for each of a plurality of contact centers associated with an organization. The icon for each contact center indicates the relative impact of the event on that particular contact center. In some examples, map chart 600 may visualize the impact of an event via the intensity of the colors displayed for each contact center site (e.g., a dark red icon at a site location may indicate a high impact level for the event, a less red icon may indicate a relatively lower level impact level, a blue icon may indicate no impact, etc.). Alternatively, map chart 600 may display a numerical score at each site location indicative of the relative impact level that an event had on the site.

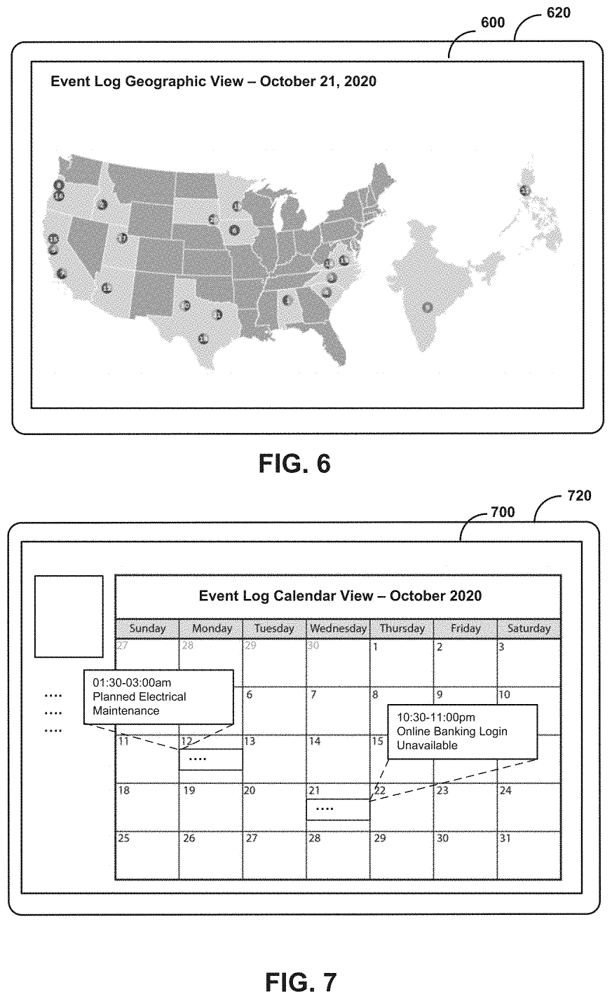

FIG. 7 shows an example calendar chart 700 that may be generated by a reporting unit, such as reporting unit 250 of event log system 200 as shown in FIG. 2, including event log entries displayed on the calendar day(s) associated with each event, and displayed on a user computing device 720, in accordance with one or more techniques of this disclosure. For example, calendar chart 600 includes two example events, one scheduled event (“Planned Electrical Maintenance” on Oct. 12, 2020) and one unscheduled event (“Online Banking Logins Unavailable” from 10:30-11:00 pm on Oct. 21, 2020). The “Online Banking Logins Unavailable” corresponds to the event described above with respect to FIGS. 4 and 5. Calendar charts of the type shown in FIG. 7 may be useful when planning contact center operations in view of upcoming scheduled events, or to view past scheduled or unscheduled events and gain insight into contact center performance that may be associated with the scheduled or unscheduled event.

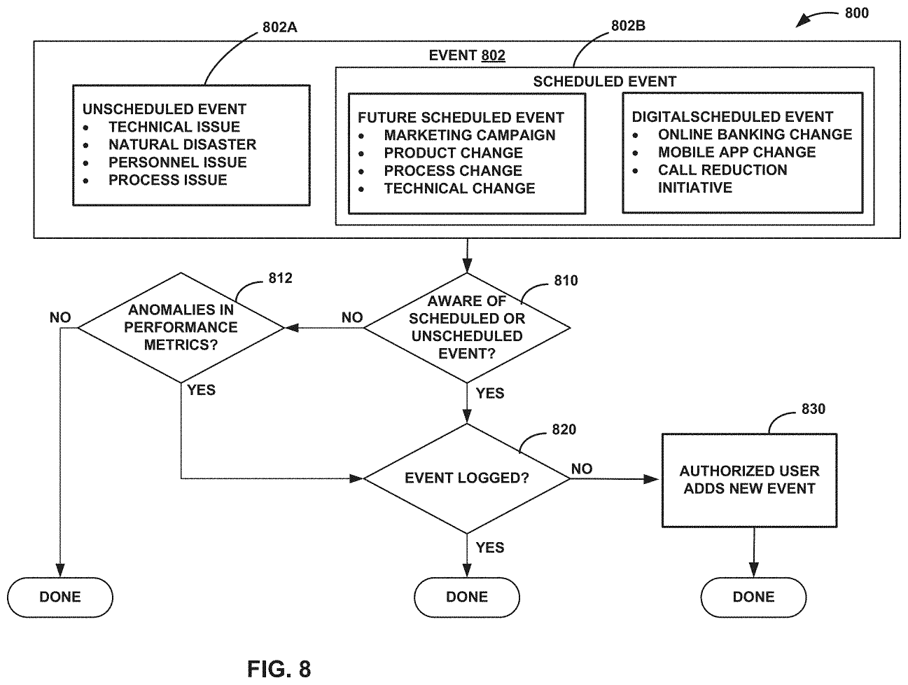

FIG. 8 is a flowchart illustrating an example event log data input process (800) by which an event log computing system may receive and store event data input by a human user into an event log interface, in accordance with one or more techniques of this disclosure. Events (802) may include unscheduled events (802A) and/or scheduled events (802B). Examples of unscheduled events (802A) include, but are not limited to, an unexpected technical issue, a natural disaster, a personnel issue, a process issue, or any other unscheduled event that may have an impact on the operation of the contact center. Examples of scheduled events (802B) may include, but are not limited to, scheduled events such as a marketing campaign, a product change, a process change, a scheduled technical change, a scheduled digital event such as online banking change, a mobile app change, a call reduction initiative, or any other scheduled event that may have an impact on the operation of the contact center.

When a user becomes aware of a scheduled or unscheduled event (YES branch of 810), the user may check the event log system to determine whether the event has already been entered into the event log (820). If so, (YES branch of 820), no further event data entry is required and the process with respect to the event is complete. If the event has not been entered into the event log (NO branch of 820), an authorized user inputs event data associated with the event into the event log (830). For example, event log system may generate, for display on the authorized user computing device, an event log interface 300 such as shown in FIGS. 3A and 3B, by which the authorized user may input event data associated with the event.

If the user is not aware of an event (NO branch of 810), event log system 200 may alert the user as to the presence of anomalies in one or more performance metrics (812). If there are no anomalies in the performance metrics (NO branch of 812), the process is complete. If there are anomalies in one or more performance metrics (YES branch of 812), the event log system may determine whether there is an event in the event log corresponding to the anomalies (820). If there is an event in the event log corresponding to the anomalies (YES branch of 820), the process is complete. If there is not an event in the event log corresponding to the anomalies (NO branch of 820), an authorized user inputs event data associated with an event corresponding to the anomalies into the event log (830). For example, event log system may generate, for display on the authorized user computing device, an event log interface 300 such as shown in FIGS. 3A and 3B, by which the authorized user may input event data associated with the event corresponding to the anomalies into the event log.

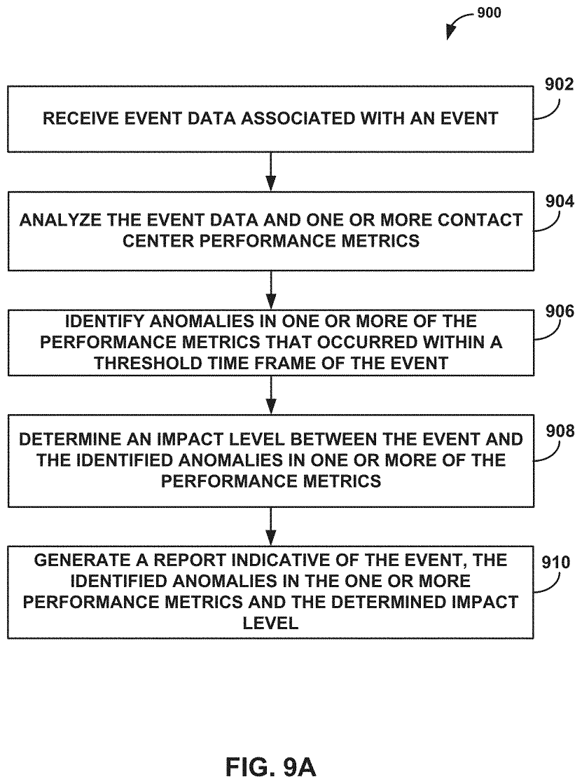

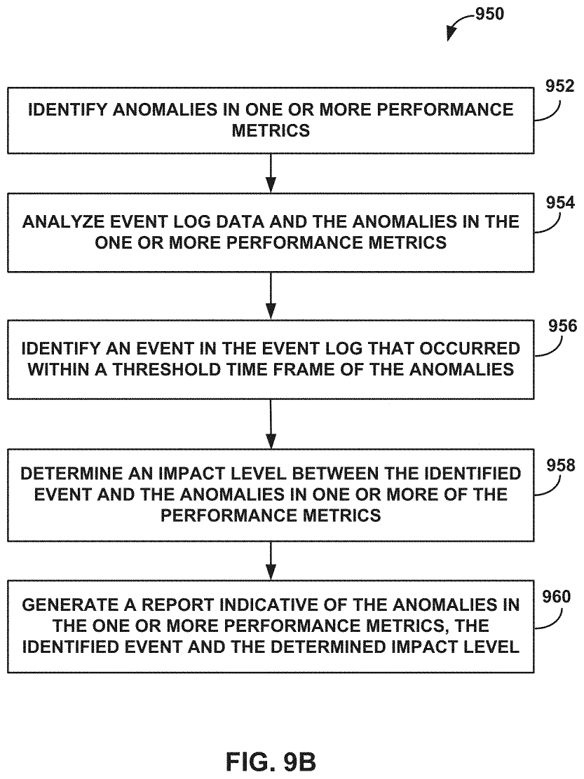

FIG. 9A is a flowchart illustrating an example process (900) by which an event log system, such as event log system 200 as shown in FIG. 2, may analyze event data associated with an event and contact center performance metrics to determine an impact level of the event on the one or more contact center performance metrics. Event log system 200 receives event data associated with an event (902). For example, event log system may receive event data input by a user into an event log interface, such as event log interface 300 as shown in FIGS. 3A and 3B.

Event log system 200 analyzes the event data associated with the event and one or more contact center performance metrics (904). Event log system 200 identifies anomalies in one or more of the performance metrics that occurred within a threshold time frame of the event. For example, event log system 200 may identify anomalies in one or more performance metrics that occurred within the same time frame as the event, that occurred within a threshold time frame after a start of the event, that occurred within a threshold time frame after an end of the event, or within any other specified threshold time frame with respect to the event.

Event log system 200 determines an impact level between the event and the identified anomalies in the one or more performance metrics (908). The impact level may include, for each performance metric, one of no impact, low impact, moderate impact, or high impact. Event log system 200 may determine the impact level for each performance metric based on one or more impact thresholds. The impact thresholds for each performance metric may include a no impact threshold, a low impact threshold, a moderate impact threshold, and a high impact threshold. One or more of the threshold(s) maybe expressed as a percentage above or below the forecasted value for the performance metric. In addition, or alternatively, one or more threshold(s) may be expressed as an absolute value above or below the forecasted value for the performance metric.

Event log system 200 generates one or more reports indicative of the event, the event data, the identified anomalies in the one or more performance metrics, and/or the determined impact level (910). The report(s) may include, but are not limited to, any one or more of a graph, a chart, a table, a map chart, and a calendar chart.

FIG. 9B is a flowchart illustrating an example process (950) by which an event log computing system may analyze event data and anomalies in contact center performance metrics to identify events in the event log that may be related to the anomalies in the performance data. Event log system 200 analyzes one or more contact center performance metrics to identify anomalies in one or more performance center metrics (952). Event log system 200 may determine a presence of an anomaly for a performance metric based on one or more impact thresholds. The impact thresholds for each performance metric may include a no impact threshold, a low impact threshold, a moderate impact threshold, and a high impact threshold. One or more of the threshold(s) maybe expressed as a percentage above or below the forecasted value for the performance metric. In addition, or alternatively, one or more threshold(s) may be expressed as an absolute value above or below the forecasted value for the performance metric.

Event log system analyzes the event data in the event log corresponding to one or more events and the anomalies in the one or more performance metrics (954) and identifies an event in the event log that occurred within a threshold time frame of the anomalies (956). For example, event log system 200 may identify an event in the event log that occurred within the same time frame as the anomalies, that occurred within a threshold time frame before a start of the anomalies, that occurred within a threshold time frame after an end of the anomalies, or within any other specified threshold time frame with respect to the anomalies.

Event log system 200 determines an impact level between the event and the identified anomalies in the one or more performance metrics (958). The impact level may include, for each performance metric, one of no impact, low impact, moderate impact, or high impact. Event log system 200 may determine the impact level for each performance metric based on one or more impact thresholds. The impact thresholds for each performance metric may include a no impact threshold, a low impact threshold, a moderate impact threshold, and a high impact threshold. One or more of the threshold(s) maybe expressed as a percentage above or below the forecasted value for the performance metric. In addition, or alternatively, one or more threshold(s) may be expressed as an absolute value above or below the forecasted value for the performance metric.

Event log system 200 generates one or more reports indicative of the event, the event data, the identified anomalies in the one or more performance metrics, and/or the determined impact level (960). The report(s) may include, but are not limited to, any one or more of a graph, a chart, a table, a map chart, and a calendar chart.

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A computing system comprising:
a memory storing an event log including event data associated with each of a plurality of events impacting operations of a contact center; and
one or more processors in communication with the memory and configured to:
generate an event log interface for display on a user computing device associated with one or more authorized users, wherein the event log interface includes one or more user interface elements for input of event data associated one or more events;
analyze one or more contact center performance metrics to identify one or more anomalies in the one or more contact center performance metrics;
in response to identifying at least one of the plurality of events in the event log that occurred within a threshold time frame of the identified anomalies, associating the identified event with the identified anomalies;
determine, for each of the contact center performance metrics, an impact level of the event corresponding to an actual impact that the event had on the contact center performance metric based on the identified anomalies; and
generate, for display on a user computing device, one or more reports indicative of the event data, the contact center performance metrics, and the impact level.

2. (canceled)

3. The computing system of claim 1, wherein the impact level includes one of a no impact level, a low impact level, a moderate impact level, or a high impact level.

4. The computing system of claim 1, wherein the one or more processors are further configured to:
determine, based on the event data for one of the plurality of events, a start date associated with the event; and
identify the anomalies in the one or more contact center performance metrics that occurred within a threshold time frame of the start date associated with the event.

5. The computing system of claim 1, wherein to determine, for each of the performance metrics, the impact level of the event on the one or more contact center performance metrics, the one or more processors are further configured to:
determine a difference between an actual value of the performance metric with a forecasted value of the performance metric; and
assign the impact level based on the determined difference.

6. The computing system of claim 5, wherein to assign the impact level based on the determined difference, the one or more processors are further configured to:
compare the determined difference to a threshold corresponding to an impact level.

7. The computing system of claim 1, wherein the event data includes an event name, an event date, an event type, an estimated list of one or more performance metrics impacted by the event, and an estimated impact level.

8. The computing system of claim 1, wherein the event includes one of a scheduled event or an unscheduled event.

9. The computing system of claim 8, wherein the scheduled event includes any one of a marketing campaign, a product change, a process change, or a technical change.

10. The computing system of claim 8, wherein the unscheduled event includes any one of a technical issue or a natural disaster.

11. The computing system of claim 1, wherein the one or more reports include one of a table, a graph, a map chart, or a calendar chart.

12. A method comprising:
storing, by at least one storage device, an event log including event data associated with each of a plurality of events impacting operations of a contact center;
generating, by one or more processors, an event log interface for display on a user computing device associated with one or more authorized users, wherein the event log interface includes one or more user interface elements for input of event data associated one or more events;
analyzing, by the one or more processors, one or more contact center performance metrics to identify anomalies in the one or more contact center performance metrics;
in response to identifying at least one of the plurality of events in the event log that occurred within a threshold time frame of the identified anomalies, associating the identified event with the identified anomalies;
determining, by the one or more processors and for each of the contact center performance metrics, an impact level of the event corresponding to an actual impact that the event had on the contact center performance metric based on the identified anomalies; and
generating, by the one or more processors and for display on a user computing device, one or more reports indicative of the event data, the contact center performance metrics, and the impact level.

13. (canceled)

14. The method of claim 12, wherein the impact level includes one of a no impact level, a low impact level, a moderate impact level, or a high impact level.

15. The method of claim 12, wherein identifying anomalies in the one or more contact center performance metrics that may be associated with the event further comprises:
determining, based on the event data for one of the plurality of events, a start date associated with the event; and
identifying anomalies in the one or more contact center performance metrics that occurred within a threshold time frame of the start date associated with the event.

16. The method of claim 12, wherein determining, for each of the performance metrics, the impact level of the event on the performance metric, further comprises:
determining a difference between an actual value of the one or more contact center performance metrics with a forecasted value of the one or more contact center performance metrics;
comparing the determined difference to a threshold corresponding to an impact level; and
assigning the impact level based on the determined difference.

17. The method of claim 12, wherein the event data includes an event name, an event date, an event type, an estimated list of one or more performance metrics that may be impacted by the event, and an estimated impact level.

18. The method of claim 12, wherein the event includes one of a scheduled event or an unscheduled event.

19. The method of claim 12, wherein the one or more reports include one of a table, a graph, a map chart, or a calendar chart.

20. A non-transitory computer readable medium comprising instructions that when executed cause one or more processors to:
store an event log including event data associated with each of a plurality of events impacting operations of a contact center;
generate an event log interface for display on a user computing device associated with one or more authorized users, wherein the event log interface includes one or more user interface elements for input of event data associated one or more events;
analyze one or more contact center performance metrics to identify anomalies in the one or more contact center performance metrics;
in response to identifying at least one of the plurality of events in the event log that occurred within a threshold time frame of the identified anomalies, associate the identified event with the identified anomalies;
determine, for each of the contact center performance metrics, an impact level of the event corresponding to an actual impact that the event had on the contact center performance metric based on the identified anomalies; and
generate, for display on a user computing device, one or more reports indicative of the event data, the contact center performance metrics, and the impact level.

21. The computing system of claim 1 wherein the one or more processors are further configured to:
in response to determining that no event in the event log corresponds to one of the one or more identified anomalies, automatically generate the event log interface for display on the user computing device associated with at least one of the one or more authorized users, wherein the event log interface includes one or more user interface elements for input of event data associated with an unscheduled event corresponding to the identified anomalies.

22. The computing system of claim 1 wherein the one or more processors are further configured to:
in response to determining that no event in the event log corresponds to one of the one or more identified anomalies:
automatically generate a report for display on the user computing device associated with at least one of the one or more authorized users indicative of the identified anomalies; and
automatically generate the event log interface for display on the user computing device associated with at least one of the one or more authorized users, wherein the event log interface includes one or more user interface elements for input of event data associated with an unscheduled event corresponding to the identified anomalies.

23. The computing system of claim 1, wherein the one or more processors are further configured to automatically invoke an action to address the identified anomalies.
